(19) United States
(12) Patent Application Publication
(10) Pub. No.: US 2025/0309535 A1
(43) Pub. Date: Oct. 2, 2025

(54) MULTI-BAND ANTENNA FOR VEHICLE

(71) Applicant: ACE TECHNOLOGIES CORPORATION, Incheon (KR)

(72) Inventors: Seyoung PARK, Seoul (KR); Taeil KIM, Goyang-si, Gyeonggi-do (KR); Jinsoo JEON, Incheon (KR); Jinkyu HWANG, Incheon (KR)

(21) Appl. No.: 19/088,025

(22) Filed: Mar. 24, 2025

(30) Foreign Application Priority Data
Mar. 28, 2024 (KR) 10-2024-0042688

(51) Int. Cl. H01Q 5/30; H01Q 1/32; H01Q 1/48

(52) U.S. Cl. CPC H01Q 5/30; H01Q 1/48; H01Q 1/32

(57) ABSTRACT

The present disclosure provides a multi-band antenna for a vehicle comprising: a ground panel and a plurality of radiators, each independently manufactured by processing a metal plate to have an embossed structure having a convex pattern region; a connector module having connectors; and a substrate on which the ground panel, the plurality of radiators, and the connector module are joined, and on which a plurality of transmission lines are formed for electrically connecting the joined connector and each of the plurality of radiators to each other. According to the multi-band antenna of the present disclosure, performance can be improved while reducing the size and significantly reducing the manufacturing cost.

### CROSS-REFERENCE TO RELATED APPLICATIONS

This application claims priority under 35 U.S.C. § 119 (a) to Korean Patent Application No. 10-2024-0042688, filed on Mar. 28, 2024, with the Korean Intellectual Property Office, the disclosure of which is incorporated herein in its entirety by reference.

### BACKGROUND

### 1. Technical Field

The present disclosure relates to an antenna for a vehicle, and more particularly, to a multi-band antenna for a vehicle that receives frequencies of multiple communication bands such as LTE and 5G.

### 2. Description of the Related Art

Recently, in the vehicle interior, the instrument panel cluster and air conditioning display devices are changing to flat display devices, and AVN (Audio, Video, Navigation) and various buttons are disappearing from the center fascia, and instead, various electronic components for driving convenience and autonomous driving are being added. Therefore, the space for devices that can be installed inside the vehicle is limited, and miniaturization of the vehicle-mounted antenna is required. In addition, it is necessary to reduce the manufacturing cost of the antenna.

FIGS. 1 and 2 show examples of conventional vehicle antennas.

FIG. 1 shows a single-band antenna, in which a substrate 12 is placed on the lower case of a case 11, a flat ground 13 is formed on one side of one surface of the substrate 12, and a radiator 14 is formed on the other side. Here, the flat ground 13 and the radiator 14 are formed in the form of a two-dimensional metal thin film on one surface of the substrate 12. And a connector module 16 to which a feed signal is applied is coupled to one side end of the substrate 12. The connector module 16 and the radiator 14 can be electrically connected through a transmission line 19 formed in the form of a metal thin film on the substrate 12. Here, as shown in FIG. 1, the transmission line 19 and the radiator 14 are formed apart from the flat ground 13.

The antenna shown in FIG. 1 has a flat ground 13 and a radiator 14 formed over a large area on one surface (or the other surface) of the substrate 12. This is because the pattern and size of the radiator 14 and the flat ground 13 are determined according to the frequency band and intensity of the signal that the antenna is intended to transmit and receive. In other words, not only does the size of the antenna increase, but the size of the substrate 12, which requires a relatively high cost compared to other configurations, cannot be reduced, making it difficult to reduce the manufacturing cost.

Meanwhile, FIG. 2 shows a multi-band antenna including two radiators 24 and 25. In the multi-band antenna of FIG. 2, similarly to the single-band antenna of FIG. 1, a substrate 22 is placed on the lower case of a case 21, and a flat ground 23 is formed in the form of a two-dimensional metal thin film on one surface (or the other surface) of the substrate 22. However, in the multi-band antenna of FIG. 2, only the flat ground 23 is formed on the substrate 22, and the first and second radiators 24 and 25 are formed as two-dimensional metal thin films on separate sub-substrates, respectively.

The two sub-substrates on which the first and second radiators 24 and 25 are formed are vertically connected to one surface of the substrate 22. A connector module 26 is coupled to one side end of the substrate 22 as in FIG. 1, and since the antenna is a multi-band antenna including two radiators 24 and 25 here, the connector module 26 includes two connectors. In addition, a feed line (not shown) is formed together on the surface on which the flat ground 23 is formed, so that the first and second connectors and the first and second radiators 24 and 25 can be electrically connected.

In the case of the multi-band antenna shown in FIG. 2, since two radiators 24 and 25 for different frequency bands must be provided, the size of the flat ground 23 must be larger than that of the antenna of FIG. 1, and thus the flat ground 23 is formed over the entire area of the substrate 22. Accordingly, if the two radiators 24 and 25 are formed on the substrate 22 together with the flat ground 23 as in FIG. 1, the overall area of the antenna becomes excessively large, so in the antenna of FIG. 2, the two radiators 24 and 25 are formed on separate sub-substrates and are vertically coupled to the substrate 22. Accordingly, the substrate 22 must have a size according to the flat ground 23, which must have a size corresponding to two radiators 24 and 25, and two additional sub-substrates must be used. That is, since the flat ground 23 and two radiators 24 and 25 must be individually formed on the substrate 22 and two sub-substrates, the manufacturing cost increases significantly. Moreover, there is a problem that the height of the antenna increases significantly as the two radiators 24 and 25 are vertically coupled to the substrate 22.

In addition, in FIGS. 1 and 2, the connector modules 16 and 26 are coupled to one side of the substrate 12 and 22 and protrude toward the outer side of the case. This is to minimize the size of both antennas, but there is a problem that in order to actually mount the antenna in a vehicle, a space larger than the size of the case 11 and 21 is required due to the protruding connector modules 16 and 26.

### SUMMARY OF THE INVENTION

An object of the present disclosure to provide a multi-band antenna for a vehicle that can be reduced in size, have reduced manufacturing costs, and have improved performance.

According to one embodiment of the present disclosure, a multi-band antenna for a vehicle comprises: a ground panel and a plurality of radiators, each independently manufactured by processing a metal plate to have an embossed structure having a convex pattern region; a connector module having connectors; and a substrate on which the ground panel, the plurality of radiators, and the connector module are joined, and on which a plurality of transmission lines are formed for electrically connecting the joined connector and each of the plurality of radiators to each other.

The substrate may have a ground contact pattern formed with which a part of a lower region other than the convex pattern region of the ground panel is in direct contact.

The ground panel may be placed between the plurality of radiators on the upper part of the substrate.

The substrate may have a plurality of radiator contacts formed around the side ends thereof, each of which is electrically connected to the plurality of radiators, and each of the plurality of radiator contacts may have one end connected to the other end of the transmission line, one end of which is connected to one of a plurality of connectors of the connector module.

The substrate may have a plurality of coupling contacts formed at adjacent locations of each of the plurality of radiator contacts and electrically connected to the ground panel, thereby causing a coupling phenomenon between each of the plurality of radiators and the ground panel.

The ground contact pattern may be formed in a distributed manner so that an area excluding an area where the plurality of radiator contacts and the plurality of coupling contacts are formed on the side end portions of the upper surface of the substrate and an area where the connector module is joined is included inside.

The substrate may have a plurality of radiator fastening holes formed within the plurality of radiator contacts so that a portion of the plurality of radiators is inserted and penetrated through the radiator fastening holes, and ground fastening holes formed within the plurality of coupling contacts so that a portion of the ground panel is inserted and penetrated through the ground fastening holes.

The ground panel may have a plurality of coupling joining protrusions formed in a protruding shape extending from a lower region formed on the periphery, and inserted through the ground fastening holes.

Each of the plurality of radiators may have a radiator joining protrusion formed in a protruding shape extending from a lower region formed on the periphery, and inserted through the radiator fastening hole.

According to one embodiment of the present disclosure, a multi-band antenna for a vehicle comprises: a ground panel and a plurality of radiators, each independently manufactured by processing a metal plate to have an embossed structure having a convex pattern region; a connector module having connectors; a substrate on which the ground panel, the plurality of radiators, and the connector module are joined, and on which a plurality of transmission lines are formed for electrically connecting the joined connector and each of the plurality of radiators to each other; and a case in which the ground panel, the plurality of radiators, the connector module, and the substrate are arranged, and a substrate arrangement region is formed in a central region spaced apart from the side surface to arrange and fix the substrate.

The case may be divided into an upper case and a lower case, and each of the upper and lower cases may be formed as a multi-curved structure in which the heights of the beam region corresponding to the frame and the plate region which is the remaining region are different.

The lower case may have a substrate mounting groove formed in a region in contact with the substrate arrangement region in the plate region, in which an edge of the substrate is positioned and fixed.

The case may have an inner connector mounting recess formed on one side where the connector module joined to the substrate is placed so that the connector module does not protrude outward, and is inserted into the inside.

The lower case may be formed with a two-stage push-on stud that is joined with a push-on fastener formed on the ground panel and the first and second radiators to secure the ground panel and the first and second radiators.

The multi-band antenna for a vehicle of the present disclosure can reduce the size and greatly reduce the manufacturing cost while improving the performance by forming each of a plurality of radiators and a ground with a metal plate having a three-dimensional hierarchical embossed structure having a convex pattern region and joining it with a substrate.

### BRIEF DESCRIPTION OF THE DRAWINGS

FIGS. 1 and 2 show examples of conventional vehicle antennas.

FIGS. 3 and 4 show the overall configuration of a multi-band antenna for a vehicle according to one embodiment.

FIG. 5 is a drawing for explaining an embossed structure of a radiator and a ground according to one embodiment.

FIGS. 6 and 7 are drawings for explaining a detailed structure of a lower case.

FIG. 8 is a drawing for explaining a structure of a substrate and a connector module.

FIGS. 9 to 11 are drawings for explaining a joined structure of a substrate and a connector module.

FIG. 12 is a drawing for explaining a structure of a radiator and a ground.

FIGS. 13 to 15 are drawings for explaining a method of joining a radiator and a ground.

### DETAILED DESCRIPTION OF THE INVENTION

Hereinafter, specific embodiments according to embodiments of the present disclosure will be described with reference to the drawings. The following detailed description is provided to assist in a comprehensive understanding of the methods, apparatus and/or systems described herein. However, this is only an example, and the present disclosure is not limited thereto.

In describing the embodiments, when it is determined that detailed descriptions of known technologies related to the present disclosure may unnecessarily obscure the gist of the disclosed embodiments, detailed descriptions thereof will be omitted. In addition, terms used below are defined in consideration of functions in the present disclosure, which may vary depending on the customary practice or the intention of users or operators. Therefore, the definition should be made based on the contents throughout this specification. The terms used in the detailed description are only for describing embodiments, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, parts or combinations thereof, other than those described. In addition, terms such as “unit”, “device”, “module”, “block”, and the like described in the specification refer to units for processing at least one function or operation, which may be implemented by hardware, software, or a combination of hardware and software.

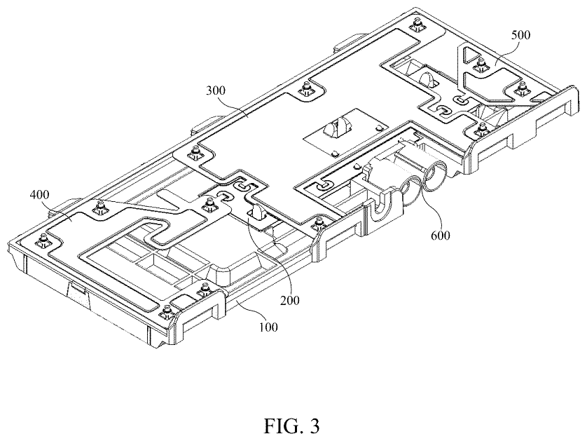

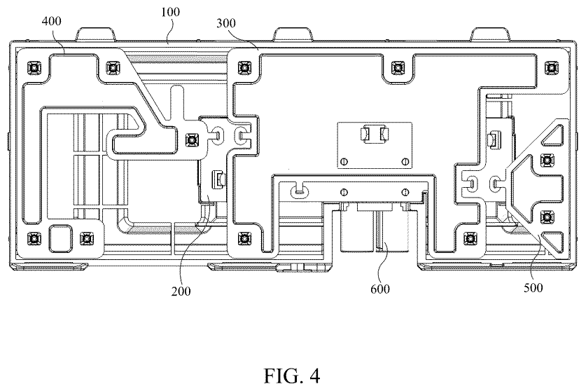

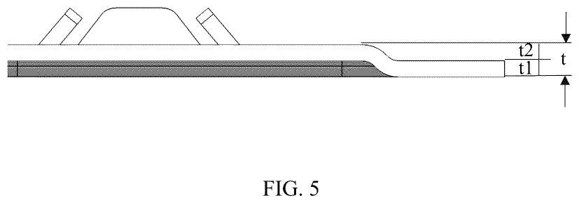

FIGS. 3 and 4 show the overall configuration of a multi-band antenna for a vehicle according to one embodiment, and FIG. 5 is a drawing for explaining an embossed structure of a radiator and a ground according to one embodiment.

Referring to FIGS. 3 to 5, a multi-band antenna for a vehicle according to one embodiment may be configured to include a case 100, a substrate 200, a ground panel 300, first and second radiators 400 and 500, and a connector module 600.

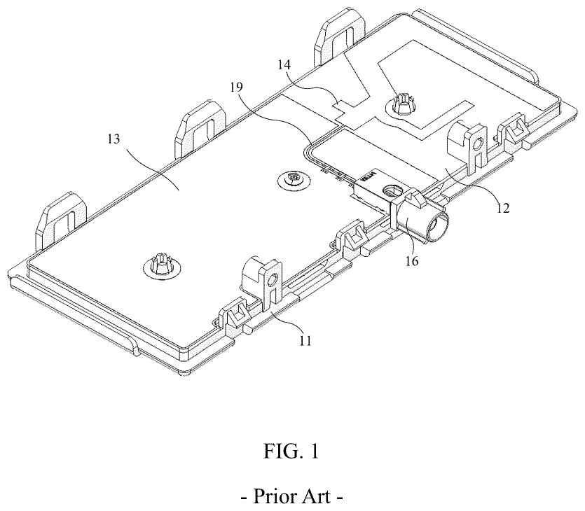

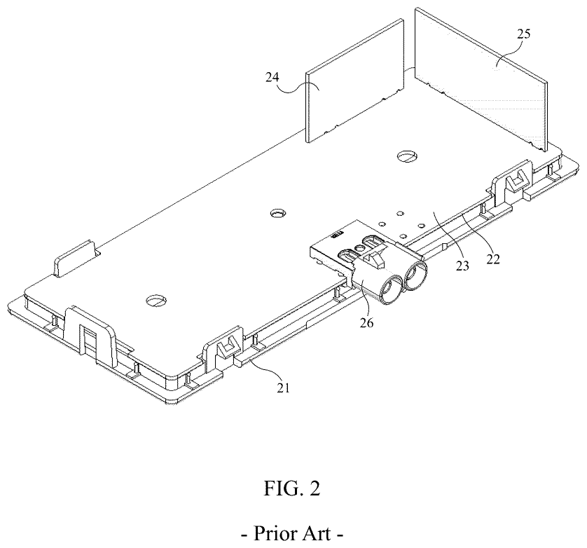

The case 100 forms the exterior of the multi-band antenna and serves to protect various components placed inside from external impact or pressure. The case 100 may be divided into a lower case and an upper case that are connected to each other, but, as in FIG. 1 and FIG. 2, only the lower case of the case 100 is shown here for convenience of explanation.

Meanwhile, unlike in FIGS. 1 and 2, in one embodiment, the ground 30 and the first and second radiators 400 and 500 are not formed on the substrate 200, but are formed as independent metal plates. However, in one embodiment, the ground 30 and the first and second radiators 400 and 500 are each formed not as a two-dimensional flat metal plate as is, but as a three-dimensional hierarchical embossed structure with a convex pattern region. As shown in FIGS. 3 to 5, the ground 30 and the first and second radiators 400 and 500 may be formed as a two-layered structure in which a region designated by a certain pattern on a two-dimensional metal plate is formed as a convex pattern region that is relatively higher than other regions. Here, the embossed structure having a convex pattern region can be easily formed by pressing the metal plate, and the relative height t2 of the convex pattern region compared to other regions on the metal plate can be variously adjusted. In this way, when the ground 30 and the first and second radiators 400 and 500 are formed in an embossed structure, the thickness of the ground 30 and the first and second radiators 400 and 500 increases, but this is very small and has little effect on the size of the entire antenna. In contrast, as the ground 30 and the first and second radiators 400 and 500, which were previously formed as a two-dimensional metal plane on the substrate, are converted to a three-dimensional structure having a height, a large change occurs in the volume of the ground 30 and the first and second radiators 400 and 500.

For example, the convex pattern area may be formed to be as high as the thickness t1 of the metal plate, as shown in FIG. 3 (t1=t2). If the thickness of the metal plate is 0.2 mm, the ground 30 and the first and second radiators 400 and 500 having a three-dimensional embossed structure may have a height of 0.4 mm. In this case, since the thickness is doubled compared to a two-dimensional metal plate of the same area, the volume increases eight times. Therefore, the two-dimensional size, i.e., the area, of the ground 30 and the first and second radiators 400 and 500 can be greatly reduced, while improving performance.

In addition, when the size of the ground 30 and each of the first and second radiators 400 and 500 are reduced, as shown in FIGS. 3 and 4, the ground 30 and the first and second radiators 400 and 500 can be placed on the same plane in a smaller area than the existing antenna. In addition, even though it is a multi-band antenna, the height does not need to increase, unlike the multi-band antenna of FIG. 2, which requires a significant increase in height by vertically joining the radiators 24 and 25 with respect to the substrate 22. Accordingly, the multi-band antenna can be manufactured in a compact size.

Here, it is assumed that the multi-band antenna transmits and receives signals of two different frequency bands (e.g., LTE and 5G frequency bands) and thus is illustrated as having two radiators 400 and 500, but the number and shape of the radiators can be variously adjusted depending on the frequency of the signal required for the antenna.

In addition, since the ground 30 and the first and second radiators 400 and 500 are formed as separate metal plates from the substrate 200, the substrate 200 in the antenna of one embodiment is provided only to ensure that signals are stably transmitted between the connector module 600 and the first and second radiators 400 and 500. Therefore, the size of the substrate 200 requiring high cost can be significantly reduced, thereby reducing the manufacturing cost. In particular, since separate sub-substrates for the first and second radiators 400 and 500 are not required, the manufacturing cost can be further reduced.

The connector module 600 is joined to the substrate 200, and receives a signal received through the first and second radiators 400 and 500 through a transmission line formed on one surface of the substrate 200 and transmits it to an external device, or applies a feed signal applied from an external device to the transmission line. In particular, in the antennas of FIGS. 1 and 2, the connector modules 16 and 26 protrude laterally from the case 11 and 21, and therefore, a larger space than the case is required to actually mount the antenna in the vehicle. This is because the size of the substrate 12 and 22 is already very large, so the substrate 12 and 22 must be placed all the way to the inner edge of the case 11 and 21, making it difficult to place the connector module 16 and 26 inside the case 11 and 21. However, in the antenna of one embodiment, the case 100 has a size in which the ground 30 and the first and second radiators 400 and 500 can all be placed, but the size of the substrate 200 is relatively very small compared to that. Accordingly, in this case, the connector module 600 can be placed in the extra space from one side of the substrate to the outer side of the case, obtained by placing the substrate 200 on the inner central side of the case 100. That is, the connector module 600 can be placed so that it does not protrude beyond the outer side of the case 100. Therefore, no additional space is required due to the connector module 600 when mounting the antenna.

Hereinafter, each component of the multi-band antenna according to one embodiment and a method of joining them will be described in detail.

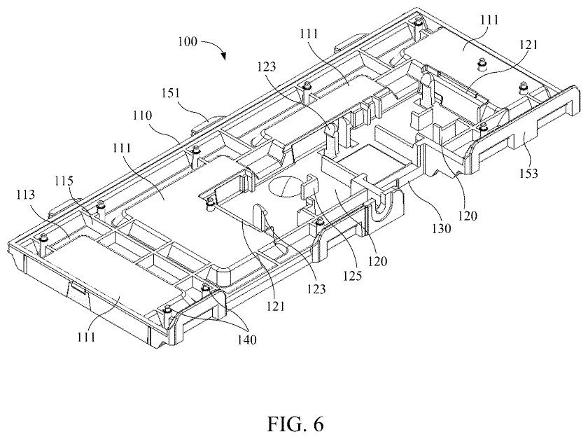

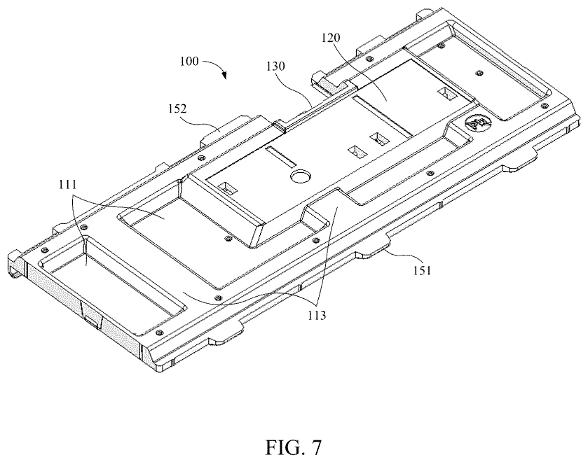

FIGS. 6 and 7 are drawings for explaining a detailed structure of a lower case.

The case 100 may be implemented with a plastic material to minimize the influence on the signal transmission and reception of the radiator 400 and 500 and the increase in thickness. In addition, as shown in FIGS. 6 and 7, the lower case may have a multi-curved structure rather than a box structure with a uniform height on the lower surface, and in particular, in order to increase the rigidity against twisting and bending, it may have an H-shaped multi-curved structure in which the heights of the beam region 113 corresponding to the frame and the plate region 111, which is the remaining region, are different. In FIGS. 6 and 7, the beam region 113 formed at a certain interval on the outer edge and inside of the lower case and performing the function of the frame may be formed narrower and lower than the plate region 111, while the plate region 111 may be formed higher and wider than the beam region 113. The plate region 111 can serve as a support to designate the height at which the ground panel 300 and the first and second radiators 400 and 500 are placed and prevent them from bending under pressure. In addition, an auxiliary support 115 may be further formed in the beam region 113 corresponding to the frame to further reinforce the rigidity against twisting and bending.

Meanwhile, a substrate arrangement region 120 for arranging and fixing the substrate 200 is formed in a central region spaced apart from the side surface of the lower case. The substrate arrangement region 120 may be formed lower than the plate region 111 so that the substrate 200 can be arranged, similar to the frame region. In addition, a substrate mounting groove 121 may be formed in a region of the plate region 111 that comes into contact with the substrate arrangement region 120 to allow the substrate to be mounted thereon. The substrate mounting groove 121 serves to fix the substrate 200 arranged in the lower case without moving forward, backward, left, or right or shaking. In addition, a plurality of substrate joining hooks 123 are formed in the substrate arrangement region 120 to allow the substrate 200 to be fastened and fixed to the lower case. In addition, a plurality of substrate supports 125 are formed inside the substrate arrangement region 120 to allow the substrate to be stably maintained without being broken or bent even when pressure is applied to the substrate 200 fastened to the lower case in the direction of the lower surface. The substrate joining hooks 123 and the substrate supports 125 also play a role in suppressing the up-and-down movement of the substrate 200 fastened to the lower case.

In addition, a portion of the side outer surface of the lower case is formed in a form inserted into the substrate arrangement region 120 to form an inner connector mounting recess 130. As shown in FIGS. 1 and 2, the inner connector mounting recess 130 is a space for arranging a connector module 600 joined to a substrate 200, and allows the connector module 600 together with the substrate arrangement region 120 formed in the central area of the lower case to be arranged in the inner region of the case 100. That is, by preventing the connector module 600 from protruding outside the case 100, the space required for mounting the antenna can be reduced.

In addition, a plurality of metal plate fastening structures 140 protruding toward the upper surface may be formed in the lower case. The plurality of metal plate fastening structures 140 may be formed in various shapes as a means for fixing the ground panel 300 and the first and second radiators 400 and 500 formed using metal plates to the lower case, but here, as an example, it is assumed and illustrated that the ground panel 300 and the first and second radiators 400 and 500 are formed in the form of a two-stage push-on stud having a structure protruding toward the upper case in the shape of a two-stage cylinder of different diameters so that they can be easily fastened and fixed to the lower case in a push-on manner.

Additionally, clip structures 151 and 153 for joining and fastening with the upper case (not shown) may be formed on the outer surface of the lower case. The clip structures 151 and 153 may also be formed in various forms, but here, it is assumed that a protruding mold 151, which protrudes from the outer side of the lower case, and a clip mold 153, which extends from the outer side toward the upper surface and has an internal hole into which a protruding mold 151 formed in the upper case is inserted and joined, are formed. In one embodiment, it is shown that a protruding mold 151 is formed on one side of the lower case, and a clip mold 153 is formed on the other side. However, in some cases, a protruding mold 151 or a clip mold 153 may be formed on both sides of the lower case, and a protruding mold 151 or a clip mold 153 that is not formed on the lower case may be formed on both sides of the upper case.

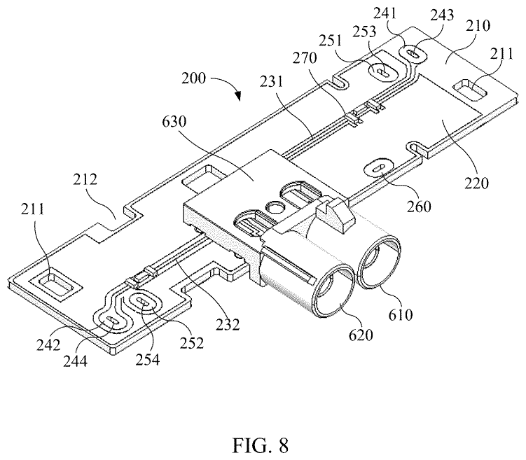

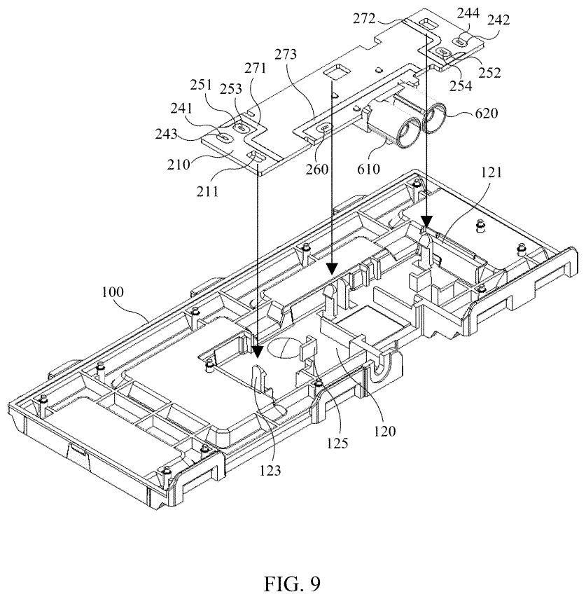

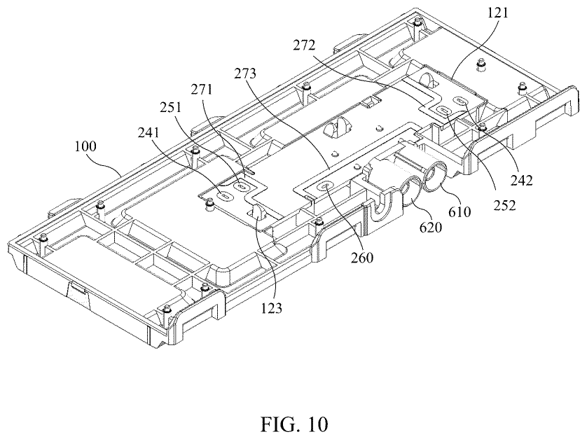

FIG. 8 is a drawing for explaining a structure of a substrate and a connector module, and FIGS. 9 to 11 are drawings for explaining a joined structure of a substrate and a connector module. FIG. 8 shows a perspective view of the lower surface of the substrate 200 joined to the lower case, and for a perspective view of the upper surface, reference may be made to FIGS. 9 and 10.

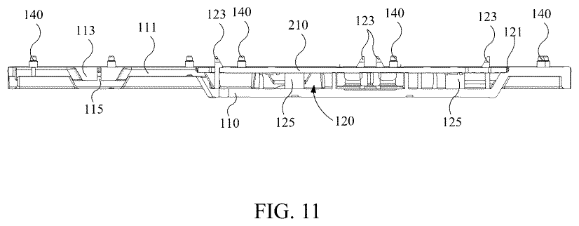

As described above, in one embodiment, the ground panel 300 and the first and second radiators 400 and 500 are not formed on the substrate 200 but are independently formed using separate metal plates, so that the substrate 200 can be formed in a much smaller size than before. The substrate 200 can be implemented as a PCB, etc., and may be formed with a hook insertion hole 211 or a hook joining groove 212, etc., to which the substrate joining hook 123 of the lower case is fastened, so that it can be stably placed and fixed to the lower case. As shown in FIGS. 9 and 10, the substrate 200 can be placed in the substrate arrangement region 120 formed in the lower case, and when pressure is applied from above, the substrate joining hook 123 is fastened through the hook insertion hole 211 and the hook joining groove 212, and at this time, the edge of the substrate 200 is placed in the substrate mounting groove 121 so that the substrate 200 is stably fixed. The substrate 200 placed in the substrate arrangement region 120 of the lower substrate 200 can be supported by the substrate mounting groove 121 and the substrate support 125 so that the upper surface becomes the same height as the plate region 111 of the lower case, as shown in FIG. 11.

In addition, on one surface of the substrate 200 (here, as an example, the lower surface), first and second transmission lines 231 and 232 may be formed, each of which has one end connected to the first and second connectors 610 and 620 of the connector module 600 joined with the substrate 200. The other ends of the first and second transmission lines 231 and 232 may be formed near the two side ends so as to be spaced the furthest from each other on one surface of the substrate 200, and first and second radiator contacts 241 and 242 are formed on the other ends of the first and second transmission lines 231 and 232, respectively. In addition, first and second radiator fastening holes 243 and 244 are formed in the center of the first and second radiator contacts 241 and 242. The first and second radiator contacts 241 and 242 are connected to the first and second radiators 400 and 500 when the first and second radiators 400 and 500 are joined to the substrate 200 through the first and second radiator fastening holes 243 and 244, so that the connectors 610 and 620 and the first and second radiators 400 and 500 are electrically connected. The first and second transmission lines 231 and 232 are formed near both side ends of the substrate in order to suppress mutual influence of signals transmitted from the first and second radiators 400 and 500 as much as possible. In addition, a DTC (Digital Tunable Capacitor) circuit 270 may be further formed on the path of the first and second transmission lines 231 and 232 to check for a failure of the antenna.

In addition, two coupling contacts 251 and 252 may be formed on the substrate 200 at positions adjacent to each of the first and second radiator contacts 241 and 242, and ground fastening holes 253 and 254 may be formed in the center of the coupling contacts 251 and 252. The ground fastening holes 253 and 254 are holes formed to join the ground panel 300 formed of a metal plate and the substrate 200. The coupling contacts are also electrically connected to the ground panel 300, and in particular, in one embodiment, the first and second radiator contacts 241 and 242 and the coupling contacts 251 and 252 are arranged adjacently so that coupling occurs while the first and second radiators 400 and 500 and the ground panel 300 are each joined to the substrate 200. As a coupling phenomenon occurs between the first and second radiators 400 and 500 and the ground panel 300 at the first and second radiator contacts 241 and 242 and the coupling contacts 251 and 252, the performance of the antenna can be improved even if the sizes of the first and second radiators 400 and 500 and the ground panel 300 are reduced.

As shown in FIGS. 9 and 10, the first and second radiator contacts 241 and 242 and the coupling contacts 251 and 252 may be formed not only on the lower surface of the substrate 200 but also on the upper surface, centered on the first and second radiator fastening holes 243 and 244 and the ground fastening holes 253 and 254 formed through the substrate 200. That is, the first and second radiator contacts 241 and 242 and the coupling contacts 251 and 252 may be formed on both the upper and lower surfaces of the substrate.

Meanwhile, on the lower surface of the substrate 200, a flat ground 220 of a metal film is formed in the remaining region except for the first and second radiator contacts 241 and 242, coupling contacts 251 and 252, and the first and second transmission lines 231 and 232. The flat ground 220 may be formed in a two-dimensional flat shape similar to the flat ground 13 of the existing antenna shown in FIG. 1, and may be electrically connected to the ground lines of the two connectors 610 and 620 of the connector module 600.

Additionally, a ground fixing hole 260 may be further formed on the substrate 200. In one embodiment, the ground panel 300 may be arranged to cover most of the upper surface of the substrate 200 and may be joined to the substrate 200 by a ground fastening hole 253 and 254 formed in the center of the coupling contacts 251 and 252. However, it is difficult to stably fix the ground panel 300 to the substrate 200 with only two ground fastening holes 253 and 254 formed near both side ends of the substrate 200. Accordingly, the ground fixing hole 260 may be further formed so that the ground panel 300 can be stably fixed and joined. A substrate joining protrusion 360 inserted through the ground fixing hole 260 in the ground panel 300 may be fixed to the substrate 200 by soldering or other methods. This is to prevent the substrate joining protrusion 360 of the ground panel 300 from being detached from the ground fixing hole 260 formed in the substrate 200 even under impact or pressure.

In addition, metal ground contact patterns 271, 272 and 273 may be formed on the upper surface of the substrate 200. The ground contact patterns 271, 272 and 273 may be formed in a line shape of a pattern corresponding to the width and shape of the lower region as an area that directly contacts a portion of the remaining lower region other than the convex pattern area in the ground panel 300 formed in a three-dimensional hierarchical embossed structure. The ground contact patterns 271, 272 and 273 may be formed in a form that surrounds the upper surface of the substrate 200 so as to include most of the remaining area except for the area where the first and second radiator contacts 241 and 242 and the coupling contacts 251 and 252 formed on the side end of the substrate 200, and the ground fixing hole (260) are formed and the area where the connector module 600 is connected.

Meanwhile, the connector module 600 may be joined to the substrate 200, and may be joined to the other side end between the first and second radiator contacts 241 and 242 formed near both side ends of the substrate 200. Here, the position of the connector module 600 may be determined by considering the length required for the first and second transmission lines 231 and 232 according to the frequency of the transmitted signal. Here, since it is assumed that the antenna is a multi-band antenna capable of receiving signals of two frequency bands, the connector module 600 may include first and second connectors 610 and 620 corresponding to the first and second radiators 400 and 500, respectively.

Each of the first and second connectors 610 and 620 may be implemented as, for example, a coaxial connector, and when the connector module 600 is joined to the substrate, the signal lines of the coaxial connectors may be electrically connected to the first and second transmission lines 231 and 232, respectively, and the ground line may be electrically connected to the flat ground 220.

As described above, the connector module 600 is joined to the side end of the substrate 200 placed in the center of the case 100 and is placed in the inner connector mounting recess 130 formed in the case 100, so that it does not protrude outside the case 100.

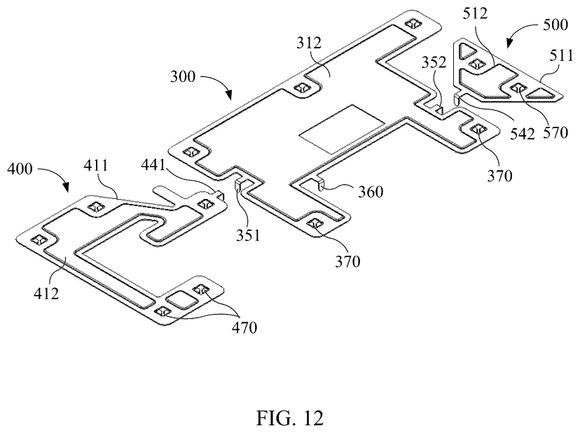

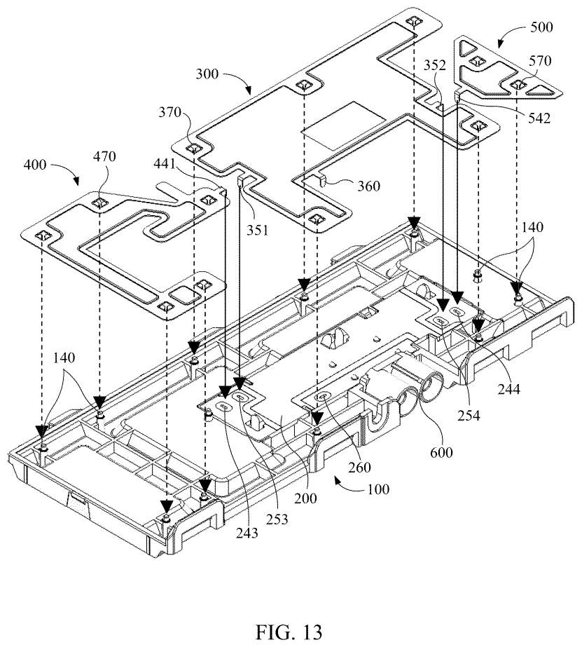

FIG. 12 is a drawing for explaining a structure of a radiator and a ground, and FIGS. 13 to 15 are drawings for explaining a method of joining a radiator and a ground.

As described above, the ground 30 and the first and second radiators 400 and 500 have an embossed structure in which convex pattern regions 312, 412 and 512 are formed by performing a process such as press processing on a metal plate. Here, the convex pattern regions 312, 412 and 512 are formed to be higher by a certain height than the remaining lower regions 311, 411 and 511. In this case, the outer edges of the ground 30 and the first and second radiators 400 and 500 may be maintained as the lower regions 311, 411 and 511.

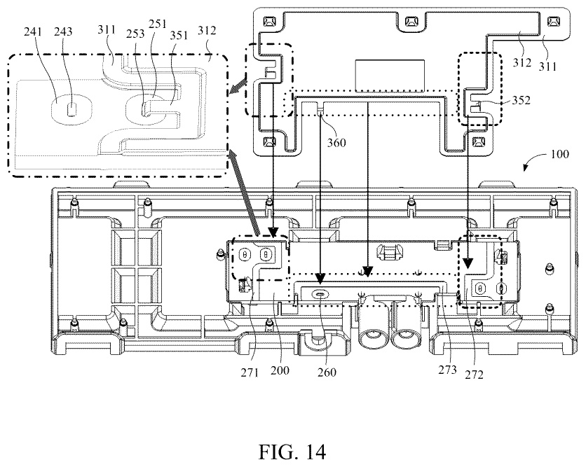

In addition, each of the first and second radiators 400 and 500 is formed with first and second radiator joining protrusions 441 and 542 for joining with the first and second radiator contacts 241 and 242 formed on the substrate 200. They may be formed in a long, protruding shape from the lower regions 411 and 511 of the first and second radiators 400 and 500, and may be bent downward for fastening with the substrate 200. As shown in FIGS. 13 and 14, the first and second radiator joining protrusions 441 and 542 are inserted through the first and second radiator fastening holes 243 and 244 formed at the center of the first and second radiator contacts 241 and 242 in the substrate 200, thereby electrically connecting the first and second radiators 400 and 500 and the first and second radiator contacts 241 and 242 formed in the substrate 200.

Likewise, in the lower region 311 of the ground panel 300, the first and second coupling joining protrusions 351 and 352 and the substrate joining protrusion 360 are formed in a long and protruding shape, and the first and second coupling joining protrusions 351 and 352 and the substrate joining protrusion 360 formed by protruding may be bent downward for fastening with the substrate 200. The first and second coupling joining protrusions 351 and 352 are joined with the first and second coupling contacts 251 and 252 corresponding to the first and second radiator contacts 241 and 242, respectively. The first and second coupling joining protrusions 351 and 352 are inserted through the ground fastening holes 253 and 254 formed in the center of the first and second coupling joining protrusions 351 and 352, thereby electrically connecting the ground panel 300 to the first and second coupling contacts 251 and 252. As described above, the substrate joining protrusion 360 is inserted through the ground fixing hole 260, thereby stably joining the ground panel 300 to the substrate 200 and preventing it from being detached.

Since the first and second radiator contacts 241 and 242 and the first and second coupling contacts 251 and 252 are arranged adjacent to each other, coupling can be formed between each of the first and second radiators 400 and 500 and the ground panel 300.

In order to stably join the ground panel 300 and the first and second radiators 400 and 500 to the substrate 200, the first and second radiator joining protrusions 441 and 542, the first and second coupling joining protrusions 351 and 352, and the substrate joining protrusion 360 may be inserted through the first and second radiator fastening holes 243 and 244, the ground fastening holes 253 and 254, and the ground fixing hole 260, and then fixed by additional means such as soldering.

In one embodiment, the ground panel 300 and the first and second radiators 400 and 500 are manufactured separately, so that the size of the substrate 200 is formed small, and as shown in FIGS. 13 and 14, the ground panel 300 is positioned between the first and second radiators 400 and 500 and is arranged and joined on the substrate 200. Accordingly, the isolation characteristics between the first and second radiators 400 and 500 and gain characteristics can be improved.

In this case, the ground panel 300 is arranged to cover all remaining areas of the substrate 200 except for the areas where the first and second radiator contacts 241 and 242 and the first and second coupling contacts 251 and 252 and the ground fixing hole 260 are formed on the substrate 200 and the area where the connector module 600 is joined. In addition, as shown in FIG. 14, a portion of the lower region 311 formed on the perimeter of the ground panel 300 can be in direct contact with the ground contact patterns 271, 272 and 273 formed on the upper surface of the substrate 200 when the ground panel 300 is joined to the substrate 200. In FIG. 14, the upper left is an enlarged view of the state in which the ground panel 300 is joined to the substrate 200. As shown in FIG. 14, the ground panel 300 is arranged to cover most of the upper region of the substrate 200, and the lower region 311 of the ground panel 300 is in direct contact with the ground contact patterns 271, 272 and 273, so that it is possible to suppress the influence of signals transmitted from the connector module 600 to the first and second radiators 400 and 500 through the first and second transmission lines 231 and 232 of the substrate 200 on each other's radiator.

In addition, a plurality of case fastening structures 370, 470 and 570 may be formed in the lower regions 311, 411 and 511 of the ground panel 300 and the first and second radiators 400 and 500 to be fastened with a plurality of metal plate fastening structures 140 formed in the lower case. The case fastening structures 370, 470 and 570 may be formed in various shapes that can be fastened with the metal plate fastening structures 140, but since it is assumed here that the metal plate fastening structures 140 are formed in a two-stage push-on stud shape, the case fastening structures 370, 470 and 570 may be formed in a push-on fastener structure.

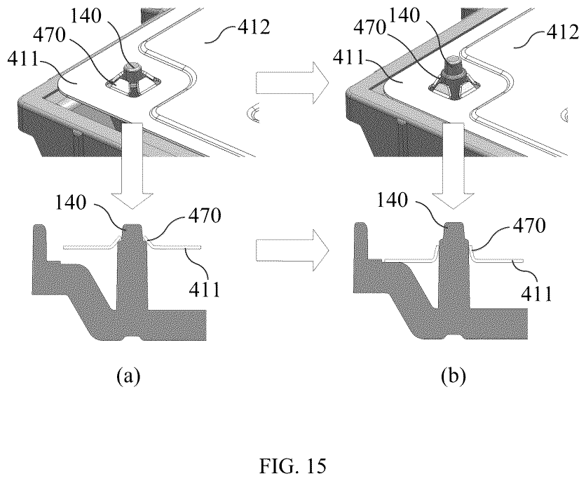

In the metal plate fastening structure 140 formed with a two-stage push-on stud and the case fastening structures 370, 470 and 570 formed with a push-on fastener structure, the ground panel 300 and the first and second radiators 400 and 500 are placed on the lower case on which the substrate 200 is already placed, as shown in FIG. 14. And as shown in FIG. 15, when the first stage of the metal plate fastening structure 140 of the lower case protrudes through the case fastening structure 370, 470 and 570 formed on the ground panel 300 and the first and second radiators 400 and 500 and spans the second stage, then the ground panel 300 and the first and second radiators 400 and 500 are simultaneously pressed downward. Once the ground panel 300 and the first and second radiators 400 and 500 are pressed downward, the second stage in the metal plate fastening structure 140 having a larger diameter than the first stage is inserted into the case fastening structure 370, 470 and 570 and protrudes, and the case fastening structure 370, 470 and 570 strongly fixes the metal plate fastening structure 140 so that it does not come off in the upward direction.

That is, the ground panel 300 and the first and second radiators 400 and 500 can be easily joined to the lower case. In this case, the first and second coupling joining protrusions 351 and 352 and the substrate joining protrusion 360 and the first and second radiator joining protrusions 441 and 542 of the ground panel 300 and the first and second radiators 400 and 500 are inserted through the ground fastening holes 253 and 254, the ground fixing hole 260, and the first and second radiator fastening holes 243 and 244, so that the ground panel 300 and the first and second radiators 400 and 500 are joined to the substrate 200, respectively.

As a result, by individually manufacturing the ground panel 300 and the first and second radiators 400 and 500 with a metal plate having an embossed structure, the multi-band antenna of one embodiment can reduce the size of each, as well as the size of the substrate 200 so that the connector module 600 does not protrude outside the case 100. In addition, the ground panel 300 is arranged to cover most of the upper area of the substrate 200 between the first and second radiators 400 and 500, and the lower region of the edge is in direct contact with the ground contact patterns 271, 272 and 273 formed on the substrate 200, thereby improving the isolation characteristics and gain characteristics. In addition, the case 100 is formed to have an H-shaped multi-curved structure, so that the substrate 200, the ground panel 300, and the first and second radiators 400 and 500 arranged inside can be protected from being bent or damaged even by various impacts or pressures, and the ground panel 300, the first and second radiators 400 and 500 can be prevented from being separated from the substrate 200.

Here, the description is made assuming that the multi-band antenna includes two radiators 400 and 500, but the radiators may be provided in multiple numbers, and accordingly, the number of connectors included in the connector module 600 and the number of transmission lines formed on the substrate may also be adjusted.

In the illustrated embodiment, respective configurations may have different functions and capabilities in addition to those described above, and may include additional configurations in addition to those described above. In addition, in an embodiment, each configuration may be implemented using one or more physically separated devices, or may be implemented by one or more processors or a combination of one or more processors and software, and may not be clearly distinguished in specific operations unlike the illustrated example.

The present disclosure has been described in detail through a representative embodiment, but those of ordinary skill in the art to which the art pertains will appreciate that various modifications and other equivalent embodiments are possible. Therefore, the true technical protection scope of the present disclosure should be defined by the claims.

What is claimed is:

1. A multi-band antenna comprising:
a ground panel and a plurality of radiators, each independently manufactured by processing a metal plate to have an embossed structure having a convex pattern region;
a connector module having connectors; and
a substrate on which the ground panel, the plurality of radiators, and the connector module are joined, and on which a plurality of transmission lines are formed for electrically connecting the connectors and each of the plurality of radiators to each other.

2. The multi-band antenna according to claim 1,
wherein the substrate has a ground contact pattern formed with which a part of a lower region other than the convex pattern region of the ground panel is in direct contact.

3. The multi-band antenna according to claim 1,
wherein the ground panel is placed between the plurality of radiators on an upper part of the substrate.

4. The multi-band antenna according to claim 1,
wherein the substrate has a plurality of radiator contacts formed around side ends of the substrate, each of which is electrically connected to the plurality of radiators, and
each of the plurality of radiator contacts has one end connected to the other end of the transmission lines, one end of which is connected to one of the connectors of the connector module.

5. The multi-band antenna according to claim 4,
wherein the substrate has a plurality of coupling contacts formed at adjacent locations of each of the plurality of radiator contacts and electrically connected to the ground panel, thereby causing a coupling phenomenon between each of the plurality of radiators and the ground panel.

6. The multi-band antenna according to claim 5,
wherein a ground contact pattern is formed in a distributed manner so that an area excluding an area where the plurality of radiator contacts and the plurality of coupling contacts are formed on side end portions of upper surface of the substrate and an area where the connector module is joined is included inside.

7. The multi-band antenna according to claim 5,
wherein the substrate has
a plurality of radiator fastening holes formed within the plurality of radiator contacts so that a portion of the plurality of radiators is inserted and penetrated through the radiator fastening holes, and
ground fastening holes formed within the plurality of coupling contacts so that a portion of the ground panel is inserted and penetrated through the ground fastening holes.

8. The multi-band antenna according to claim 7,
wherein the ground panel has a plurality of coupling joining protrusions formed in a protruding shape extending from a lower region formed on periphery, and inserted through the ground fastening holes.

9. The multi-band antenna according to claim 7,
wherein each of the plurality of radiators has a radiator joining protrusion formed in a protruding shape extending from a lower region formed on periphery, and inserted through the radiator fastening holes.

10. A multi-band antenna comprising:
a ground panel and a plurality of radiators, each independently manufactured by processing a metal plate to have an embossed structure having a convex pattern region;
a connector module having connectors;
a substrate on which the ground panel, the plurality of radiators, and the connector module are joined, and on which a plurality of transmission lines are formed for electrically connecting the connectors and each of the plurality of radiators to each other; and
a case in which the ground panel, the plurality of radiators, the connector module, and the substrate are arranged, and a substrate arrangement region is formed in a central region spaced apart from side surface to arrange and fix the substrate.

11. The multi-band antenna according to claim 10,
wherein the case is divided into an upper case and a lower case, and
each of the upper and lower cases is formed as a multi-curved structure in which heights of a beam region corresponding to a frame and a plate region which is remaining region are different.

12. The multi-band antenna according to claim 11,
wherein the lower case has a substrate mounting groove formed in a region in contact with the substrate arrangement region in the plate region, in which an edge of the substrate is positioned and fixed.

13. The multi-band antenna according to claim 10,
wherein the case has an inner connector mounting recess formed on one side where the connector module joined to the substrate is placed so that the connector module does not protrude outward, and is inserted into inside.

14. The multi-band antenna according to claim 11,
wherein the lower case is formed with a two-stage push-on stud that is joined with a push-on fastener formed on the ground panel and first and second radiators to secure the ground panel and the first and second radiators.
